(19) United States
(12) Patent Application Publication
(10) Pub. No.: US 2022/0163706 A1
(43) Pub. Date: May 26, 2022

(54) Single Element Light Folding Prism

(71) Applicant: Apple Inc., Cupertino, CA (US)

(72) Inventors: Alexander Yu Feldman, Los Altos, CA (US); Takeyoshi Saiga, Yokohama (JP); Alan Kleiman-Shwarsctein, Santa Clara, CA (US); Yoshikazu Shinohara, Cupertino, CA (US); Adar Magen, Sunnyvale, CA (US)

(73) Assignee: Apple Inc., Cupertino, CA (US)

(21) Appl. No.: 17/530,126

(22) Filed: Nov. 18, 2021

Related U.S. Application Data
(60) Provisional application No. 63/116,715, filed on Nov. 20, 2020.

(51) Int. Cl. G02B 5/04; G02B 13/00; C03C 17/00

(52) U.S. Cl. CPC G02B 5/04; C03C 2217/73; C03C 17/002; G02B 13/0065

(57) ABSTRACT

An optical system for a camera may include a lens group having a one or more lenses, a prism, and an image sensor. The prism may be a single element light folding prism positioned between the lenses and the image sensor along the optical transmitting path of the light. The prism may be constructed from a single, monolithic piece of stock material and may include at least four surfaces, which may fold the light within the prism at least four times to guide the light from the one or more lenses passing through the prism to the image sensor. The prism may also include one or more aperture masks inside the prism to reduce flare.

This application claims benefit of priority to U.S. Provisional Application Ser. No. 63/116,715, entitled “Single Element Light Folding Prism,” filed Nov. 20, 2020, and which is hereby incorporated herein by reference in its entirety.

### BACKGROUND

### Technical Field

This disclosure relates generally to optical prisms and more specifically to optical systems including single element light folding prisms for small form factor cameras.

### Description of the Related Art

Telephoto cameras generally have relatively long focal lengths and are great for capturing scenes and subject at a far distance. However, the advent of small, mobile multipurpose devices such as smartphones, tablet, pad, or wearable devices has created a need for high-resolution, small form factor cameras for integration in the devices. Telephoto cameras using light folding prisms have typically utilized composite prisms constructed from combining multiple smaller prisms. However, composite prisms may exhibit lower optical performance, such as due to optical issues introduced by the method of joining multiple prisms. Therefore, it is desirable to have single element light folding prisms constructed from a single piece of material.

### BRIEF DESCRIPTION OF THE DRAWINGS

FIGS. 1A-1B illustrate an example single element light folding prism, according to some embodiments.

FIGS. 2A-2B show an example single element light folding prism including aperture masks, according to some embodiments.

FIG. 3 shows an example optical system including a single element light folding prism, according to some embodiments.

FIG. 4 shows a high-level flowchart of method for capturing images using a camera including an optical system configured to use a single element light folding prism, according to some embodiments.

FIGS. 5A-5D illustrate various features of an example single element light folding prism, according to some embodiments.

FIG. 6 is a high-level flowchart of an example method for creating a single element light folding prism, according to some embodiments.

FIGS. 7A-7B are logical diagrams illustrating an example arrangement of features for a single element light folding prism, as in one embodiment.

FIGS. 8A-8F illustrate various details that may be incorporated when creating a single element light folding prism, according to some embodiments.

FIG. 9 is a flowchart illustrating one embodiment of a method to perform one logical phase of a manufacturing multiple single element light folding prisms from a single piece of stock material, according to some embodiments.

FIGS. 10A-F are logical block diagrams illustrating one logical phase of a method for manufacturing multiple single element light folding prisms from a single piece of stock material, according to some embodiments.

FIG. 11 is a flowchart illustrating one embodiment of a method to perform one logical phase of a manufacturing multiple single element light folding prisms from a single piece of stock material, according to some embodiments.

FIGS. 12A-F are logical block diagrams illustrating one logical phase of a method for manufacturing multiple single element light folding prisms from a single piece of stock material, according to some embodiments.

FIG. 13 is a flowchart illustrating one embodiment of a method to perform one logical phase of a manufacturing multiple single element light folding prisms from a single piece of stock material, according to some embodiments.

FIGS. 14A-F are logical block diagrams illustrating one logical phase of a method for manufacturing multiple single element light folding prisms from a single piece of stock material, according to some embodiments.

FIG. 15 is a flowchart illustrating one embodiment of a method to perform one logical phase of a manufacturing multiple single element light folding prisms from a single piece of stock material, according to some embodiments.

FIGS. 16A-C are logical block diagrams illustrating one logical phase of a method for manufacturing multiple single element light folding prisms from a single piece of stock material, according to some embodiments.

FIG. 17 illustrates a schematic representation of an example device that may include a camera having an optical system, according to some embodiments.

FIG. 18 illustrates a schematic block diagram of an example computer system that may include a camera having an optical system, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to prisms usable within optical systems for cameras (e.g., small form factor telephoto cameras). In some embodiments, the optical system may include a one or more lenses, an image sensor, and a single element light folding prism. In some embodiments, the prism may be arranged, optically, between one or more lenses and the image sensor along the optical transmitting path of light captured by the lenses to the image sensor. In some embodiments, the single element light folding prism may have at least four surfaces. For instance, the prism may include a parallelogram prism, while a first surface of the prism may be parallel to a third surface of the prism and a second surface of the prism may be parallel to a fourth surface of the prism. In some embodiments, the prism may be arranged such that the first surface may be positioned facing one or more lenses, whilst the third surface may face an image sensor. In some embodiments, the second and fourth surfaces of the prism may each include a reflective coating (or reflector), such that the second and fourth surfaces may reflect light at respective surfaces and the first and third surfaces of the prism may reflect light when the incident angle of the light is close to or greater than a critical angle at respective surfaces. Additionally, the prism may include one or more internal aperture masks to reduce or mitigate flare from stray light entering the prism.

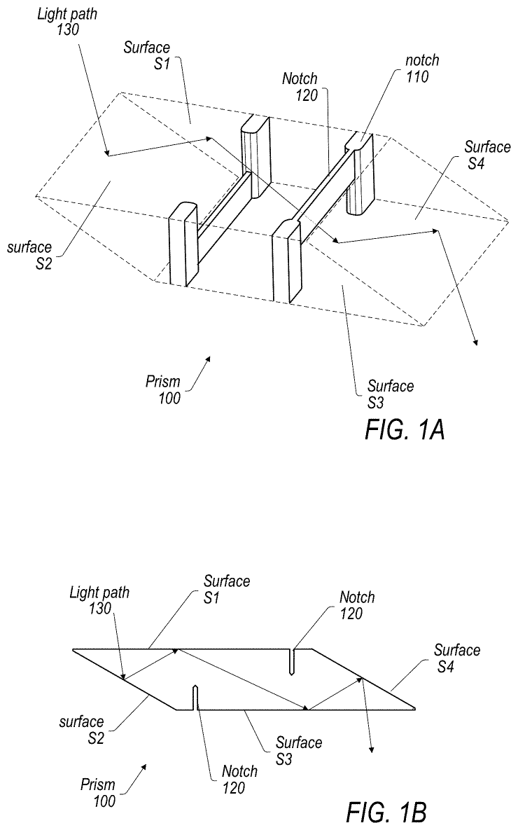

In some embodiments, the prism may fold light within the prism, guiding the light from the lenses to pass through the prism to the image sensor. FIGS. 1A and 1B illustrate, according to one embodiment, an example single element light folding prism including two aperture masks. FIG. 1A shows the basic shape of the example single element light folding prism 100 using dashed lines while illustrating various cuts, channels, notches, etc. within the prism using solid lines. For example, prism 100 includes six channels, notches or vias, cut into the surfaces of the prism: four vertical notch cuts 110 and two horizontal notch cuts 120. As will be described in more detail subsequently, these cuts may be created using any of various suitable methods, such as grinding polishing, laser cutting, laser etching, blade dicing, dicing saw, CNC machining, wire cutting, sand blasting, and/or any of various common methods to trim/process glass substrates, or may be created using a multiple, different methods (e.g., laser etching for one cut, CNC machining for another cut, a dicing saw for a different cut, or using multiple methods for a single cut, etc.). Please note that while described herein as made from glass, single element light folding prism 100 may be made from any of various suitable materials, such as glass or plastic, according to various embodiments. FIG. 1B illustrates a cross section (or slice) lengthwise through prism 100. Thus, while notch cuts 120 are illustrated in profile in FIG. 1B, vertical notch cuts 110 are not.

As noted above, single element light folding prism 100 may fold light within the prism, as illustrated by light path 130 in FIGS. 1A and 1B. For example, light may pass passing through the surface S1 of single element light folding prism 100 to enter the prism. At least some of the light may arrive at and then become reflected at the second surface S2 of the prism—e.g., the light being folded once. At least some of the light reflected from the second surface S2 of the prism may be reflected back to the first surface S1 of the prism. When the incident angle of the light is close to or larger than a critical angle of the prism, total internal reflection (TIR) may occur and the light may thus be reflected at the first surface S1 of the prism—e.g., the light being folded twice. At least some of the light reflected from the first surface S1 may transmit to and get reflected at the third surface S3—e.g., the light being folded three times. Additionally, at least some of the light reflected from the third surface s3 of the prism may reach and be reflected at the fourth surface S4 of the prism, and exit the prism—e.g., the light being folded four times. In short, in the above example of a parallelogram shaped single element light folding prism, the light may be folded four times within the prism before it exits the prism to the image sensor. Given that the prism may have multiple surfaces, the prism may be designed to be relatively thin (e.g., the length between the surfaces S1 and S3 may have a small value) but still be able to fold the light multiple times. In some embodiments, such a prism may reduce at least a height along an optical axis and accordingly may potentially reduce the entire size of an optical system.

Additionally, a single element light folding prism may include one or more internal aperture mask, while still be constructed from a single, monolithic, piece of material (e.g., glass, plastic, etc.). For example, one or more aperture masks may be created by coating one or more of the internal surfaces of the notch cuts 120 and/or the notch cuts 110. Thus, in some embodiments, a single element light folding prism (e.g., prism 100) may include a single, one-piece prism rather than being created by joining together several prisms (e.g., with an optically clear cement) as other systems may use.

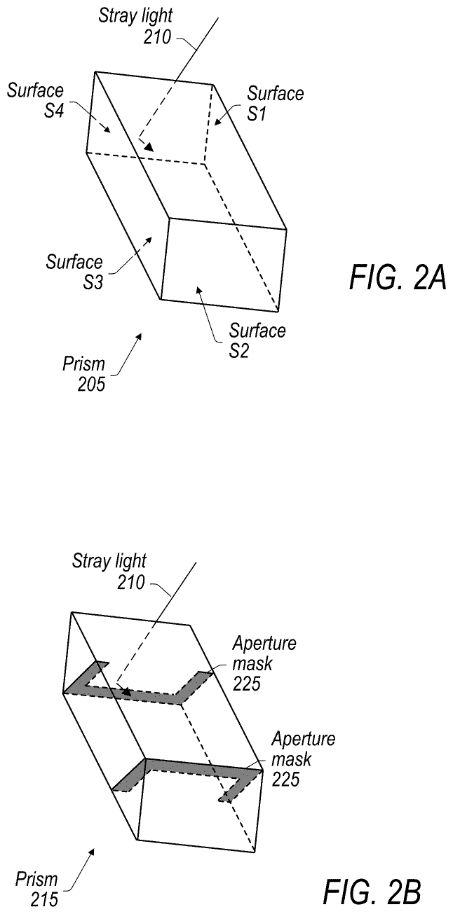

FIGS. 2A and 2B show an example single element light folding prism including internal aperture masks, according to some embodiments. In some embodiments, the internal aperture masks are provided to reduce or mitigate flare. For an optical system, flare may be caused when stray light from the environment, especially stray light brighter than light from a scene or subject which a camera is to capture, enters an optical system. The stray light from the environment may enter the optical system from various directions and/or other components of a camera (e.g., a side wall of a housing of the camera), and finally end up in the image. As shown in FIG. 2A, stray light 210 may enter prism 205, e.g., from a surface (e.g., S4) of prism 205. In some embodiments, a prism may include one or more aperture masks inside the prism and/or at a surface of the prism for reducing the flare. In this example, prism 215 may include aperture masks 225 and 230 inside prism 215 as shown in FIG. 2B. Further, in some embodiments, aperture masks 225 and/or 230 may be designed to have various shapes and/or sizes at various spatial positions. In some embodiments, the purpose may be to have aperture masks 225 and/or 230 cover the areas potentially hit by stray light from the environment. Thus, aperture masks 225 and/or 230 may intercept and absorb the stray light and thus reduce the flare, as shown in FIG. 2B. For instance, as shown in FIG. 2B, aperture masks 225 and 230 may positioned parallel to each other near opposite sides inside prism 215 to mitigate flare caused by stray light coming from opposite sides (e.g., surfaces S2 and S4) of prism 215. In some embodiments, aperture masks 225 and 230 may have the same or different shapes. As shown in this example, aperture mask 225 may have a different shape from aperture 230, such that aperture mask 225 may block stray light at the bottom and two sides whilst aperture 230 may prevent stray light at the top and two sides. Note that FIG. 2A-2B are provided merely as examples for purposes of illustration. When the flare is caused by stray light coming from one or more other directions, the size, shape, and/or position of an aperture mask may be modified accordingly to achieve the desired anti-flare performance. In some embodiments, aperture masks 225 and/or 230 may individually include an anti-flare coating, dark (e.g., black-color) masking, dark (e.g., black-color) painting, change of flange shape, and the like.

Aperture masks 225 and 230 are shown in FIG. 2B for logical illustrative purposed only and do not represent any particular size and/or shape of aperture masks used within a single element light folding prism, as described herein. For example, in some embodiments, aperture masks may be created by applying and anti-flare coating (e.g., dark or black masking) to one or more interior surfaces of channels, notches, or other cuts in prism 315.

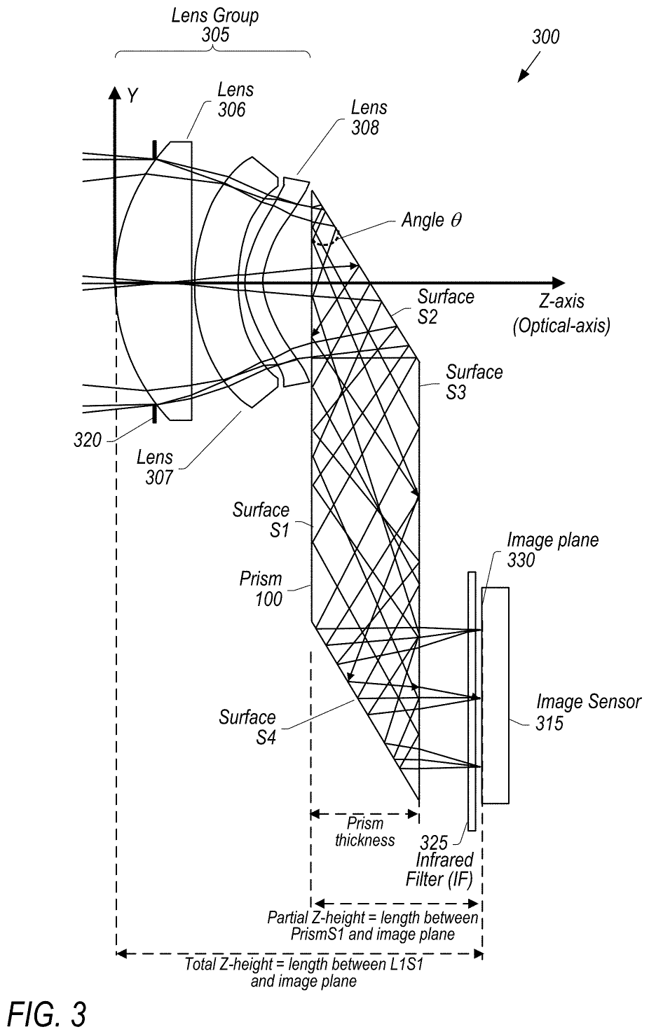

FIG. 3 shows an example optical system, according to some embodiments. In some embodiments, such and optical system may be included in telephoto cameras which may in turn may be integrated in small, mobile multipurpose devices, e.g., smartphones, tablet, pad, wearable devices, and the like. In this example, optical system 300 may include lens group 305, prism 100, and image sensor 315. FIG. 3 also illustrates a global optical coordinate system defined by Y-axis, Z-axis, and angle θ, where angle θ refers to an angle relative to Z-axis on a plane perpendicular to Y-axis. In some embodiments, lens group 305 may include a one or more lenses. In some embodiments, lens group 305 may include at least three lenses, e.g., lens 306, 307 and 308, as shown in FIG. 3. In some embodiments, optical system 300 may include aperture stop 320 which may limit and control the amount of light entering or captured by lens group 305. In some embodiments, optical system 300 may optionally include infrared filter (IF) 325, which may block or prevent at least some infrared light from reaching image sensor 315.

In some embodiments, as shown in FIG. 3, optical system 300 may include single element light folding prism 100 arranged, optically, between lens group 305 and image sensor 315 along the optical transmitting path of light from lens group 305 to image sensor 315. In some embodiments, prism 100 may include at least four surfaces. For instance, as shown in FIG. 3, prism 100 may include a parallelogram prism, while a first surface (S1) of prism 100 is parallel to a third surface (S3) of prism 100 and a second surface (S2) of prism 100 is parallel to a fourth surface (S4) of prism 100. In some embodiments, prism 100 may be arranged such that the first surface (S1) may face lens group 305, whilst the third surface (S3) may face image sensor 315. However, the surface arrangement of a single element light folding prism within an optical system may vary from embodiment to embodiment. In some embodiments, the front surface of the first lens (e.g., lens 306) of lens group 305 may be approximately parallel to image plane 330 of image sensor 315, such that light incident at the front surface of the first lens 306 may be parallel to light incident at the image plane of image sensor 315.

In some embodiments, the second surface (S2) and/or fourth surface (S4) of prism 100 may individually include a reflective coating (or reflector). For instance, the reflective coating may include mirror coating based on a thin layer of metal, a film with a white inner surface, and the like. Therefore, the second surface (S2) and fourth surface (S4) of prism 100 may reflect light at respective surfaces. The first surface (S1) and third surface (S3) of prism 100 may transmit light or pass light through respective surfaces. In addition, the first surface (S1) and third surface (S3) of prism 100 may reflect light under a phenomenon called total internal reflection (TIR). TIR may occur when the incident angle of light is close to or greater than a certain limiting angle, called the critical angle. An incident angle refers to an angle between the light incident on a surface and the line (called the normal) perpendicular to the surface at the point of incidence. Therefore, the first surface (S1) and third surface (S3) of prism 100 may pass through light when the incident angle of the light is less than the critical angle. Conversely, when the incident angle of light is close to or greater than the critical angle, the first surface (S1) and third surface (S3) of prism 100 may reflect the light at respective surfaces. In some embodiments, the first surface (S1) and/or third surface (S3) of prism 100 may further individually include an anti-reflective coating.

Referring back to FIG. 3, prism 100 may fold light within prism 100 multiple times to guide the light from lens group 305 passing through prism 100 to image sensor 315. For instance, as for single element light folding prism 100 shown in FIG. 3, light from lens group 305 may pass through the first surface (S1) of prism 100 to enter prism 100. At least some of the light may arrive at and then get reflected at the second surface (S2) of prism 100, as indicated by the edge in FIG. 3 (e.g., the light being folded once). At least some of the light reflected from the second surface (S2) of prism 100 may bounce back to the first surface (S1) of prism 100, as indicated by the edge in FIG. 3. When the incident angle of the light is close to or greater than the critical angle of prism 100, the light may be reflected at the first surface (S1) of prism 100 under TIR (e.g., the light being folded twice). Next, at least some of the light reflected from the first surface (S1) may transmit to and become reflected at the third surface prism (S3) of prism 100 (e.g., the light being folded three times). Finally, at least some of the light reflected from the third surface (S3) of prism 100 may reach the fourth surface (4) of prism 100, get reflected at the fourth surface (S4), and exit prism 100 to focus on an image plane on image sensor 315 (e.g., the light being folded four times). Therefore, in this example of FIG. 3, at least some light passing through lens group 305 may be folded four times within prism 100 before it exits prism 100 to image sensor 315.

The above described light folding of prism 100 may effectively increase the focal length between lens group 305 and image sensor 315 of optical system 300. For instance, in some embodiments, a ratio between the optical path length in prism 100 approximately from light entering prism 100 through the first surface (S1) to exiting prism 100 out of the third prism (S3) and the focal length of lens group 305 may be in a range between 0.6 and 1.0—e.g., 0.6<(optical path length in prism 100×power of lens group 305)<1.0, where power is the reciprocal of the focal length of lens group 305. Therefore, optical system 300 may use a thinner prism (e.g., having a small thickness approximately between the surface S1 and surface S3 of prism 100) yet provide a long effective focal length for telephoto cameras. For instance, in some embodiments, a ratio between a partial Z-height (e.g., measured approximately between the first surface (S1) to the image plane 330 of image sensor 315 along the optical axis or Z-axis) and a total Z-height (e.g., measured approximately between the front surface of the first lens 306 of lens group 305 to the image plane of image sensor 315 along the optical axis or Z-axis) of optical system 300, as shown in FIG. 3, may be in a range between 0.2 and 0.6—e.g., 0.2<(partial Z-height/total Z-height)<0.6, and a ratio between the thickness of prism 100 (e.g., measured approximately from the surface S1 to surface S3 of prism 100) and the thickness of lens group 305 (e.g., measured approximately from the front surface of the first lens 306 and the rear surface of the last lens 308 of lens group 305) may be in a range from 0.2 to 0.8—e.g., 0.2<(thickness of prism 100/thickness of lens group 105)<0.8, according to some embodiments. If the Z-height ratio and/or the thickness ratio is too high, prism 100 may be too large and heavy and may not effectively reduce the size of optical system 300, or lens group 305 may be too thin and may not achieve good light capture performance, according to some embodiments. Alternatively, if the Z-height ratio and/or the thickness ratio is too low, prism 100 may be too thin and may not capture sufficient light from the entire field of view (FOV). Therefore, designing optical system 300 to have appropriate parameters may reduce at least the partial Z-height and/or total Z-height of optical system 300 but still maintain high-quality optical performance. In some embodiments, the reduction of the Z-heights may accordingly decrease the size of optical system 300 and thus benefit the design and integration of small form factor telephoto cameras (using optical system 300). In some embodiments, the partial Z-height of optical system 300 may be in a range between 3.57 and 5.6 millimeters. In some embodiments, the thickness of prism 100 of optical system 300 may be in a range of 2.07 and 4.1 millimeters. In some embodiments, the effective focal length of optical system 300 may be in a range between 17.2 and 27.2 millimeters. In some embodiments, the F-number of optical system 300 may be in a range between 2.2 and 2.8.

Note that, for purposes of illustration, single element light folding prism 100 is shown as a parallelogram prism. In some embodiments, prism 100 may include other shapes, for example, a pentagon, a hexagon, and the like, and still provide the above described light folding functions and design benefits. For a given shape, the angles between individual surfaces of prism 100 may also be designed for desired performance. For instance, in some embodiments, when prism 100 includes a parallelogram prism, as shown in FIG. 3, the angle θ between the first surface (S1) and second surface (S2) of prism 100 may be in a range of 25 and 45 degrees (e.g., 25<θ<45 degrees). In some embodiments, the one or more lenses of lens group 305, e.g., lens 306, 307 and 308, may be made from various light transmitting materials. For instance, lens group 305 may include a combination of both glass and plastic lenses. In another example, all the lenses of lens group 305 may be glass lenses, or plastic lenses. Similarly, prism 100 may also include, or be made from, various optically transmitting materials (e.g., glass, plastic, etc.). Compared to glass, plastics may provide less weight and lower material cost.

In some embodiments, using a glass lens for the first lens of a lens group (e.g., lens 306) may mitigate thermal focus shift within the optical system (e.g., optical system 300). For instance, the thermal focus shift may be suppressed to less than 0.25 μm/degree. In some embodiments, using a material with a high Abbe number Vd (e.g., Vd>60) for the first lens of a lens group (e.g., lens 306) may correct axial color aberration. In some embodiments, lens groups 305 may include one or more rotationally symmetric lenses. A rotationally symmetric lens may refer to a lens with symmetric optical characteristics relative to the optical axis or Z-axis of the lens. In other words, rotation of the lens about Z-axis would not affect the optical characteristics of the lens. In some embodiments, all lenses of lens group 105 may use aspherical lenses. In some embodiments, all lenses of lens group 105 may use spherical lenses. In some embodiments, lens group 305 may include a combination of both aspherical and spherical lenses. A spherical lens may refer to a lens having a same curve across at least one surface like the shape of a ball, whilst an aspherical lens may refer to a lens having a surface which gradually changes in its curvature from the center of the lens out to the edge. In some embodiments, the aspherical lens may help optical system 300 to achieve a low F-number. For a given focal length, a lower F-number means that optical system 300 may use larger aperture stop 320, and therefore a camera including optical system 300 may have a fast shutter speed.

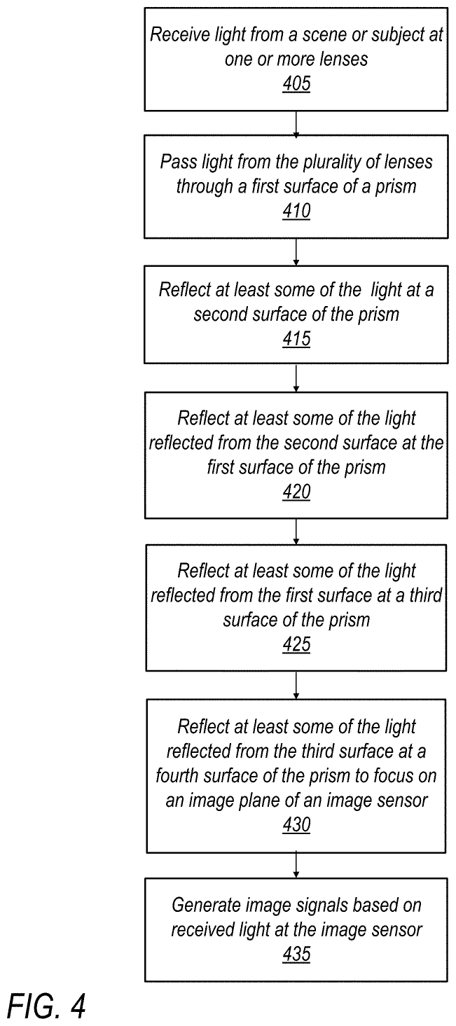

FIG. 4 shows a high-level flowchart of an example method for capturing images using a camera including an optical system, according to some embodiments. As shown in FIG. 4, in some embodiments, one or more lenses (e.g., lenses 306, 307 and 308 in FIG. 3) of an optical system (e.g., optical system 300 in FIG. 3) may receive light from a scene or subject in an environment, as indicated by block 405. In some embodiments, the optical system may include a single element light folding prism (e.g., prism 100) which may be arrange optically between the one or more lenses and an image sensor (e.g., image sensor 315) of the optical system. In some embodiments, the prism may include at least four surfaces (e.g., surfaces S1, S2, S3 and S4) which may fold light within the prism at least four times to guide the light passing through the prism from the one or more lenses to the image sensor.

As described above, in some embodiments, some surfaces of the prism (e.g., surfaces S2 and S4) may individually include a reflective coating (e.g., a mirror-like coating) or other reflector. Thus, in some embodiments, the light captured by the one or more lenses may pass through a first surface (e.g., surface S1) of the prism to enter the prism, as indicated by block 410. In some embodiments, at least some of the light passing through the first surface may arrive at a second surface (e.g., surface S2) of the prism and may be reflected at the second surface, as indicated by block 415. In some embodiments, at least some of the light reflected from the second surface may bounce back to the first surface. As described above, when the incident angle of the light is close to or greater than a critical angle of the prism, TIR may occur and the light may be further reflected at the first surface of the prism, as indicated by block 420. In some embodiments, at least some of the light reflected from the first surface of the prism may transmit to and be reflected at a third surface (e.g., surface S3) of the prism, as indicated by block 425. Similarly, when the incident angle of the light is close to or greater than the critical angle, the light may be reflected at the third surface of the prism, as indicated by block 425. In some embodiments, at least some of the light reflected from the third surface may reach and get reflected at a fourth surface (e.g., surface S4) of the prism to exit the prism to the image sensor, as indicated by block 430. In some embodiments, the image sensor may detect the light and accordingly generate image signals, e.g., electrical signals, from which images may be created, as indicated by block 435.

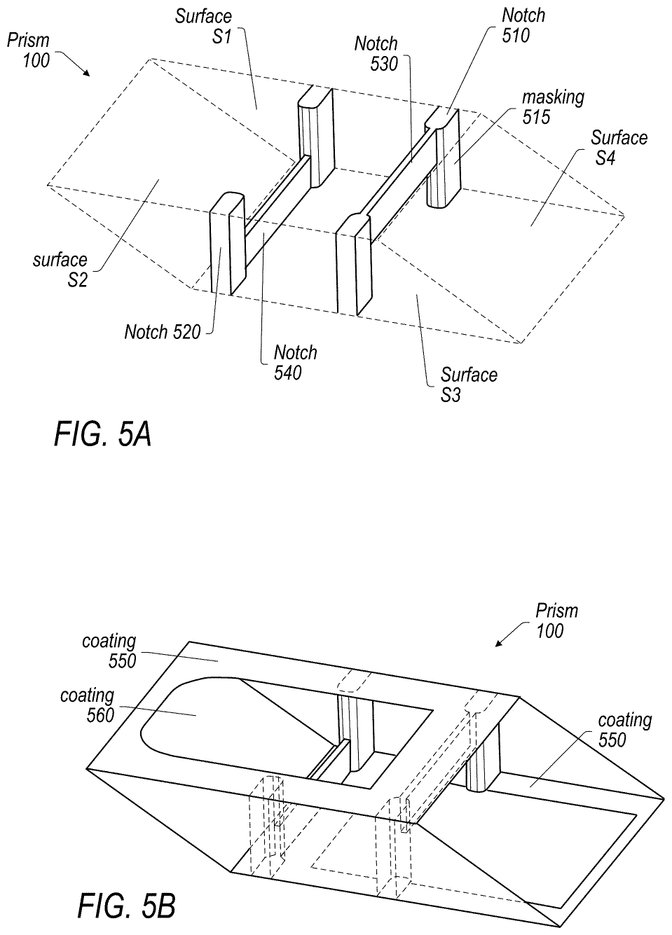

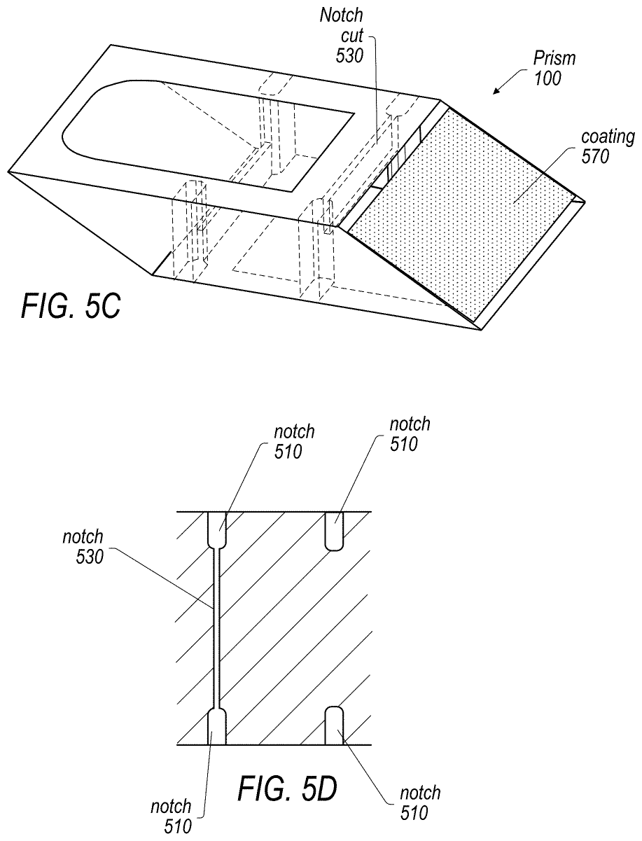

FIGS. 5A-5D illustrate various example features of a single element light folding prism, according to some embodiments. FIG. 5A shows the basic shape of the example single element light folding prism 100 using dashed lines while illustrating various cuts, channels, notches, etc. within the prism using solid lines. For example, prism 100 includes four vertical notch cuts 510 and 520 and two horizontal notch cuts 530 and 540. As will be described in more detail subsequently, these cuts may be created using any of various suitable methods, such as laser etching, cutting dicing saw, etc., or may be created using a multiple, different methods (e.g., laser etching for one cut, a dicing saw for a different cut, etc.). While described as channels and/or notches when describing a single prism, in some embodiments notch cuts 510, 520, 530 and 540 may be created by drilling, etching or otherwise cutting holes through a larger piece of stock material, such as when creating multiple prism from a single sheet or wafer of stock material, as will be described in more detail subsequently. Please note that while described herein as made from glass, a single element light folding prism may be made from any of various suitable materials, such as glass, plastic, etc., according to various embodiments.

In some embodiments, multiple cuts in a single element light folding prism may be used to allowing coatings to be applied within the interior of the prism. For example, notch 510, notch 520 and notch 530 may be used together to create an internal aperture mask within prism 100. After cuts 510, 520 and 530 are created, one or more internal surfaces of those cuts may be coated (illustrated by masking 515) to prevent light from passing through, thereby creating an internal aperture mask, according to some embodiments. While shown in FIG. 5A as essentially rectilinear is shape, notch cuts, such as notch cut 530 may be created in any of various shapes. For example, in some embodiments, notch cut 530 may be cut deeper in some areas and shallower in other, such as to make an essentially curved shape across the prism. Notches, channels and/or other cuts (as well as through glass vias, discussed subsequently) may be generated in virtually any shape desired or required for the particular prism being created, and thus may vary from embodiment to embodiment.

Similarly, additional coatings may be applied to various surfaces of the prism to either prevent light from passing through the surface or to enhance the prisms light folding ability. For example, as illustrated in FIG. 5B, mask coating 550 may be applied to surfaces S1 and S3, respectively, such as to limit the amount of stray light entering the prism. Additionally, multiple coatings may be allied to the same surface, according to some embodiments. For example, in addition to mask coating 550, one or more other coatings may be applied to surface S1, either in areas not covered by coating 550 or overlapping with coating 550, as illustrated by coating 560 in FIG. 5B.

Similarly, as shown in FIG. 5C, angled surfaces S2 and S4 may also have coatings applied. For instance, in some embodiments, a highly reflective (e.g., mirror) coating 570 may be applied to surfaces S2 and S4, thereby increasing the prisms light folding ability. While FIG. 5A-5C show certain coating applied to particular surfaces of prism 100, these are shown for illustration purposes only and additional, fewer or different numbers of coatings may be applied to greater, fewer or different surfaces of a single element light folding prism, according to various embodiments.

As noted above, one or more cuts within a prism may be utilized to create a single feature, such as combining one or more vertical channels (or notches) with a horizontal channel (or notch) to create an aperture mask. FIG. 5D illustrates a top down view of a portion of single element light folding prism 100 showing four vertical notches and one horizonal notch cut, according to one embodiment. As shown in FIG. 5D, a notch cut (or other cut) may be created that connects with other cuts, making a larger, more complex cut. For example, horizontal notch cut 530 connects with both vertical notches 520. While another notch cut may connect with vertical notches 510, it may be positioned on the bottom of prism 100 and therefore not visible in FIG. 5D, according to some embodiments.

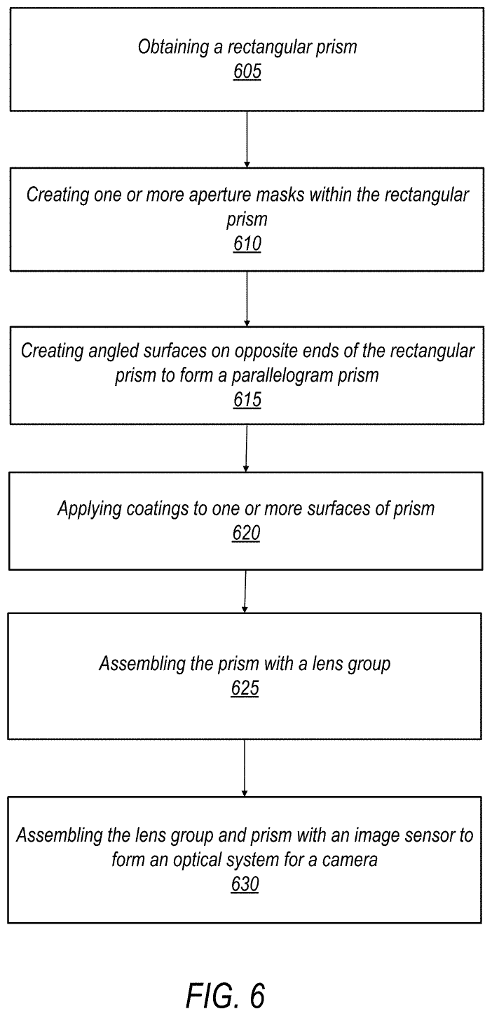

FIG. 6 shows a high-level flowchart of an example method for creating an optical system, such as example optical system 300, according to some embodiments. FIG. 6 uses a parallelogram shaped single element light folding prism, such as prism 100 in FIGS. 5A-5C, as the example for purposes of illustration. However, the features, methods, and/or mechanisms described herein may apply to prisms in other shapes and/or sizes, according to various embodiments. As shown in FIG. 6, the method may include obtaining a rectangular prism or a rectilinear piece of suitable material from which a prism may be constructed (e.g., glass or plastic), as indicated by block 605. While the example method illustrated in FIG. 6 described making a single prism from a single piece of material, in other embodiments, multiple prisms may be created from a single piece of material. For example, multiple single element light folding prisms may be created from a single glass (or plastic) wafer, as will be described in more detail below.

In some embodiments, one or more aperture masks (e.g., aperture masks 225 and/or 230) may be created at the rectangular prism, as indicated by block 610. In some embodiments, aperture masks may be created by first cutting or cutting, etching and/or carving notches channels, through vias and/or cuts into and/or through the rectangular prism and applying masking or other coatings to one or more inner surfaces of the channels, notches, though vias and/or other cuts. For example, an aperture mask may be created by first creating notches 510, 520 and 530 and then applying a mask coating to one or more interior surfaces of cuts 510, 520 and 530, such as illustrated in FIG. 5A.

In some embodiments, angled surfaces, such as surfaces S2 and S4 (shown in FIG. 5A), may be created on opposite ends of the rectangular prism to form a parallelogram shaped prism, as indicated by block 615. For example, surfaces S2 and S4 may be cut, ground and/or polished, according to various embodiments, to create the angled surfaces. For example, surfaces S2 and S4 may be created using any of various methods, such as grinding polishing, laser cutting, laser etching, blade dicing, dicing saw, CNC machining, wire cutting, sand blasting (and/or any of various common methods to trim/process glass substrates), or may be created using multiple, different methods (e.g., laser etching for one surface, CNC machining for another surface, a dicing saw for a different surface, or using multiple methods for a single surface, etc.). In some embodiments, surfaces s2 and S4 may be parallel, while in other embodiments, surfaces S2 and S4 may be created at different (e.g., non-parallel) angles. As illustrated by block 620, one or more coatings may be applied to one or more surfaces of the prism. For instance, a highly reflective (e.g., mirror) coating may be applied to the angled surfaces (e.g., surfaces S2 and S4) and a dark or black masking coating may be applied to various other surfaces, such as to at least parts of surfaces S1 and S3 as well as to one or more interior surfaces of various cuts (e.g., channels, notches and/or through vias). Such coatings, when applied to different surfaces of the prism may both prevent stray light from entering the prism and/or may enhance the reflectivity (and therefore the light folding ability) of the prism, according to some embodiments.

In some embodiments, the single element light folding prism may be assembled with a lens group including a one or more lenses (e.g., lens group 305 in FIG. 3), as indicated by block 625. For instance, the prism and the lens group may be assembled together such that a first surface (e.g., surface S1) of the prism may face a rear surface of a last lens of the lens group (as shown in FIG. 3). Therefore, light captured by the lens group may pass through the lenses of the lens group and then enter the prism through the first surface of the prism. In some embodiments, the lens group and prism may be assembled with an image sensor (e.g., image sensor 315) to form an optical system (e.g., optical system 300), as indicated by block 630. For instance, the lens group and prism may be assembled with the image sensor such that a third surface (e.g., surface S3) of the prism opposite of (and parallel to) the first surface of the prism may face the image sensor (as shown in FIG. 3). Therefore, the light from the lens group may enter the prism through the first surface, get folded inside the prism multiple times (e.g., at least four times), and pass through the third surface of the prism to the image sensor, as described above.

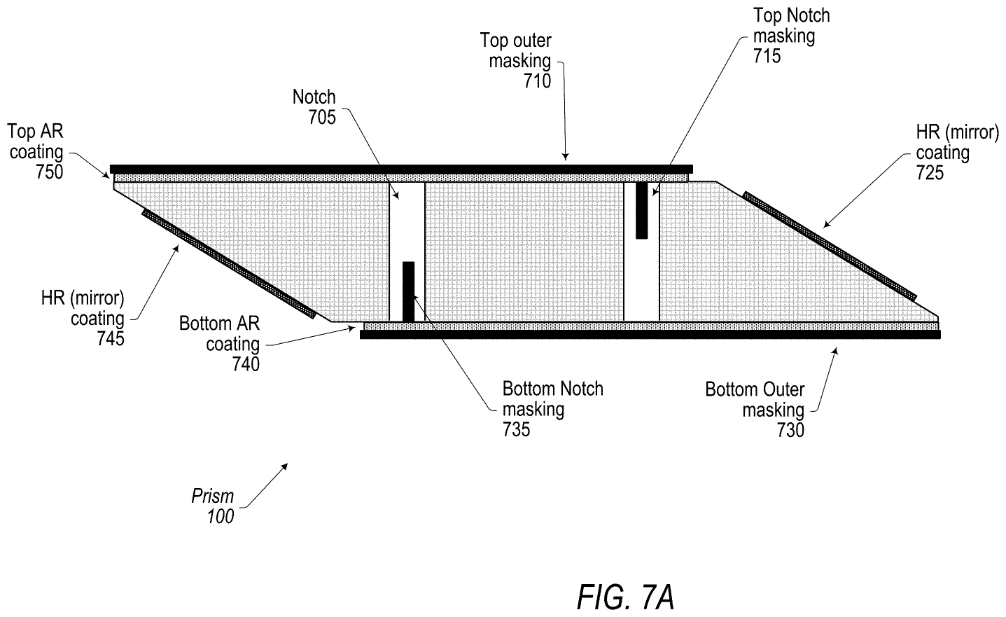

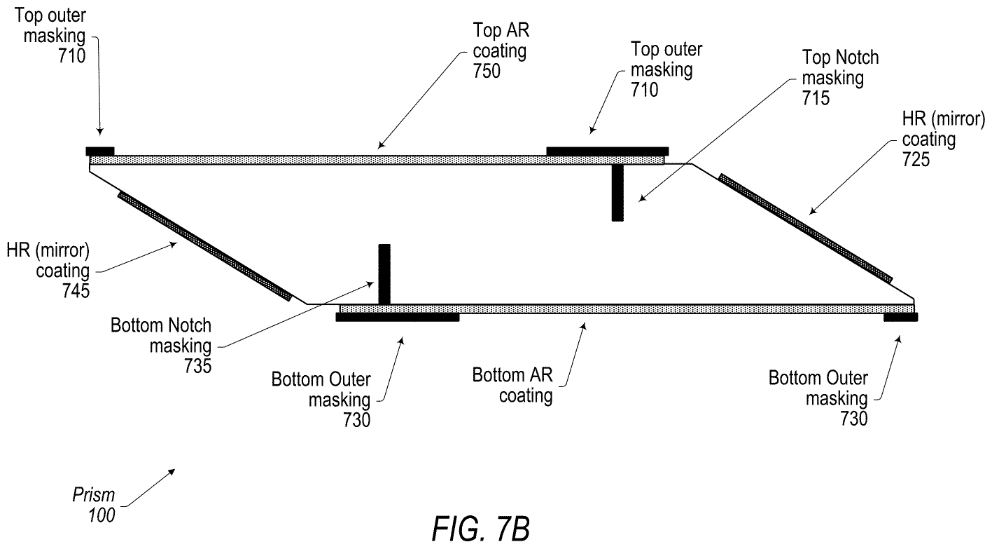

FIGS. 7A and 7B illustrate two views of a completed single element light folding prism 100, showing applied making and coatings, according to some embodiments. FIG. 7A shows a cross section near one edge of the prism 100, while FIG. 7B shows cross section through the middle of the prism 100. As described in more detail below, various coatings and/or maskings may be applied to a prism during manufacturing. For example, masking may be applied within one or more notch cuts, such as top notch masking 715 and bottom notch masking 735. As noted above, horizonal notch cuts may be combined with pairs of vertical notches, such as notch 705, and masking may be applied to create an aperture mask, according to some embodiments. Additionally, anti-reflective (AR) coatings, such as bottom AR coating 740 and top AR coating 750 may be applied to one or more surfaces of the prism 100. For instance, AR coating may be applied to surfaces S1 and S3 of single element light folding prism 100 in any of various patterns to enhance the prisms light folding abilities. While described herein generally, as applying an anti-reflective coating, in some embodiments, one or more layers of masking using any of various suitable materials (or using multiple, different materials in different layers) may be applied so as to achieve low reflection at a glass-masking interface and/or at a making-air interface (e.g., at a glass-BM interface or at a BM-air interface).

In some embodiments, two or more coatings may be applied to the same surface. For example, both top AR coating 750 and top outer masking 710 may be applied to surface S1 of prism 100. The coatings may be applied to different areas of the same surface or one coating may (at least partially) overlap another coating. For example, top AR coating 750 may be applied to a central area of surface S1 while top outer masking 710 may be applied to an area generally surrounding the area to which top AR coating 750 was applied. Additionally, top outer masking 710 may also overlap at least slightly top AR coating 750, such as assure full coverage of S1, for example. Similarly, both bottom AR coating 740 and bottom outer masking 730 may be applied to surface S3 of prism 100, according to some embodiments.

As another example, high reflective (HR) or mirror coating may be applied to one or more surfaces of a single element light folding prism. For instance, HR coatings 745 and 725 may be applied to surfaces S2 and S4, respectively) of prism 100, such as to enhance the prisms light folding capabilities. Thus, according to some embodiments, light may pass through surface S1 (within an area not blocked by top outer masking 710 and reflect of surface S2 (enhanced by HR coating 745) before continuing through prism 100, as described above.

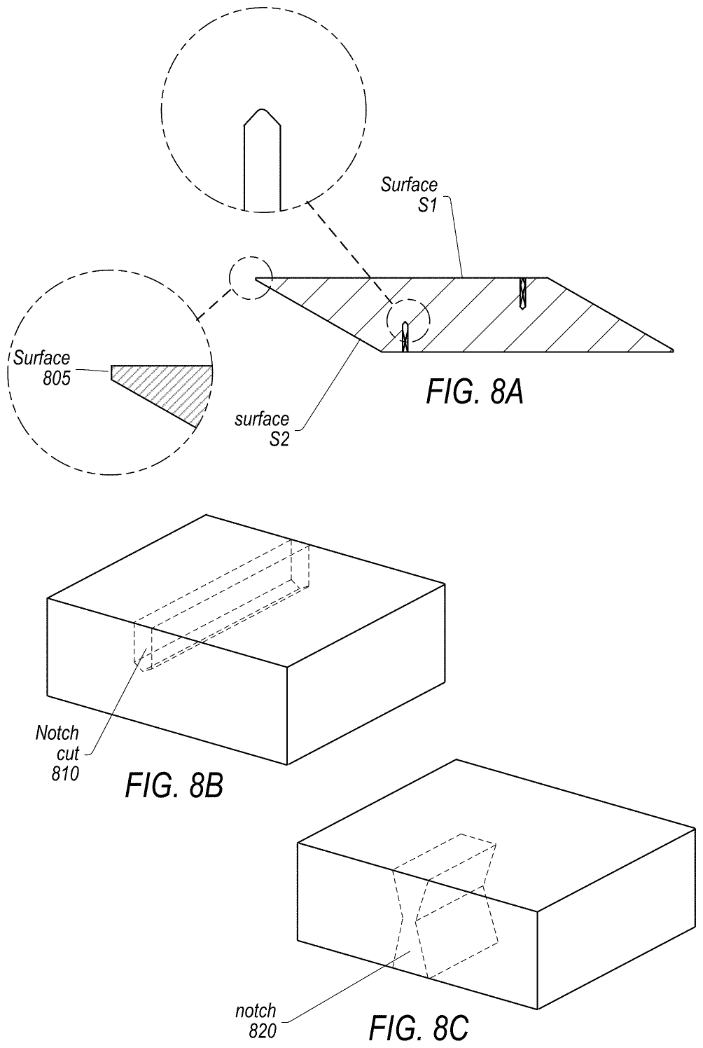

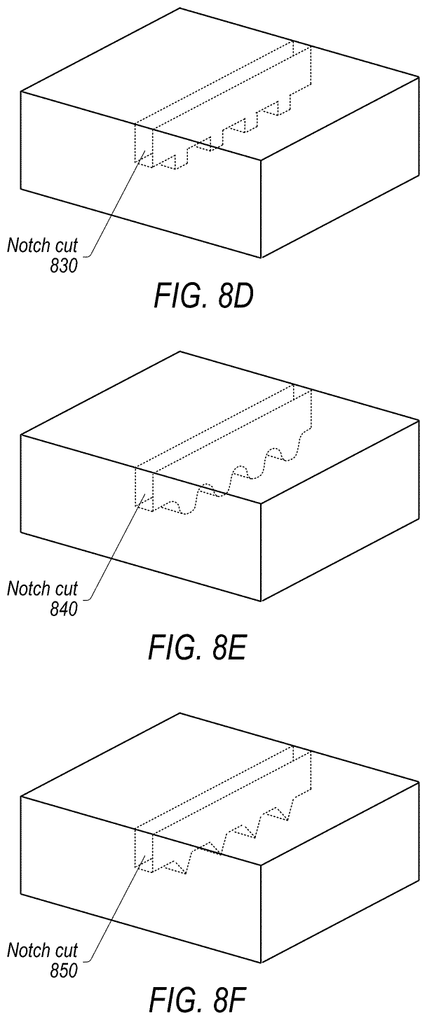

While prism 100 as well as the various through channels, notches, though vias and/or other cuts are illustrated in the figures (e.g., FIGS. 1A and 5A-5C) as having particular size and shapes, please note that different sizes and shapes may be used in various embodiments. FIGS. 8A-8C illustrate various details that may be incorporated when creating a single element light folding prism, according to some embodiments. For example, FIG. 8A illustrates a lengthwise cross section through the center of an example single element light folding prism. While generally illustrated herein as coming to a sharp point, a first surface (e.g., surface S1 of prism 100) and a second surface (e.g., surface S2 of prism 100) may not actually meet. Instead, the edge may be cut or beveled to create a surface 805 between them, such as to help prevent chipping or breaking of the prism edge, according to some embodiments.

Additionally, both FIGS. 8A through 8F illustrate that a notch cut (or any cut generally) may be creating in any of various shapes. FIGS. 8B through 8F illustrate a notch cut in a center portion of a prism, but a given prism may include multiple different such notch cuts. As shown in both FIGS. 8A and 8B, in some embodiments, a notch cut 810 may include two angled surfaces at the bottom of the notch or may be generally square or rounded (as illustrated in FIGS. 1A and/or 5A-5C). Similarly, a vertical channel, notch, through via or other cut may be created in any of various shapes such as the generally hourglass shaped notch 820 illustrated in FIG. 8C. The particular size and shape of channels, notches, through vias and/or other cuts may vary based on the purpose of the cuts and/or to make it easier to apply coatings to one or more surfaces of the cuts. For example, FIG. 8D illustrates a notch cut 830 have different depths in a varying square or rectangular pattern. FIG. 8E illustrates a notch cut 840 have different depths in a curved pattern, and FIG. 8E illustrates a notch cut 850 have different depths in a triangular pattern. Such patterns may be periodic or aperiodic. Different depth patterns and/or different notch cut shapes may be used for different notch cuts on the same prism. Although note shown in FIGS. 8B through 8F the notches may be a notch that connects side vias, channels or notches, such as shown in FIGS. 1A and 5A-D.

According to some embodiments, multiple single element light folding prisms may be created or manufactured together from a single piece of stock material. Such a manufacturing process may be divided logically into several phases. For instance, first a series of cuts may be performed on one side (e.g., the bottom) of the stock material. Additionally, coatings may be applied to that side of the stock material before turn the material over to work on the other side (e.g. the top). A series of cuts may be performed on the new side (e.g., the top) while also applying one or more coatings. The stock material may be then separated into smaller pieces of stock, such as by creating one or more bars. Additionally, cuts and coatings may be applied to each bar before the bar is separated into individual pieces to be finished as individual prisms.

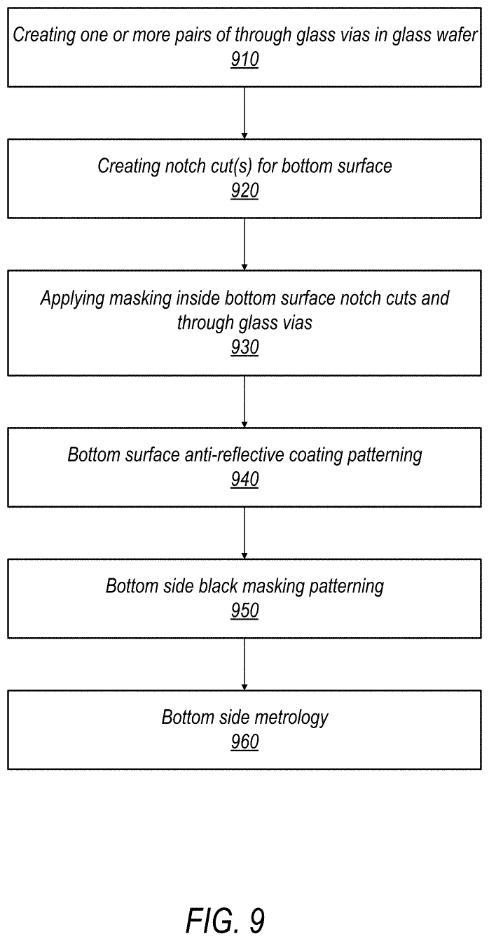

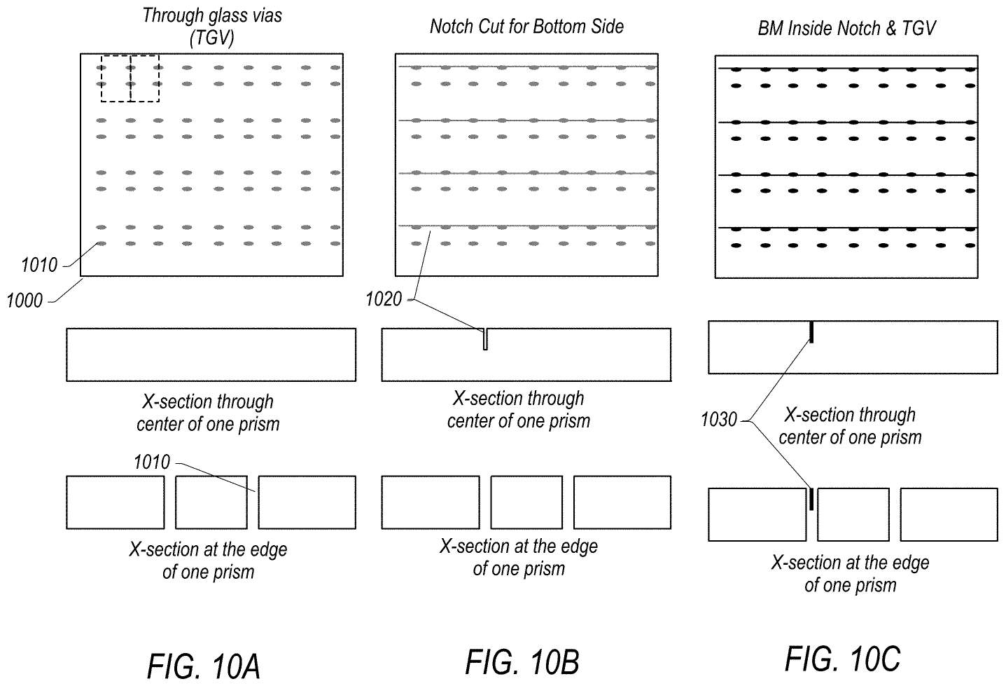

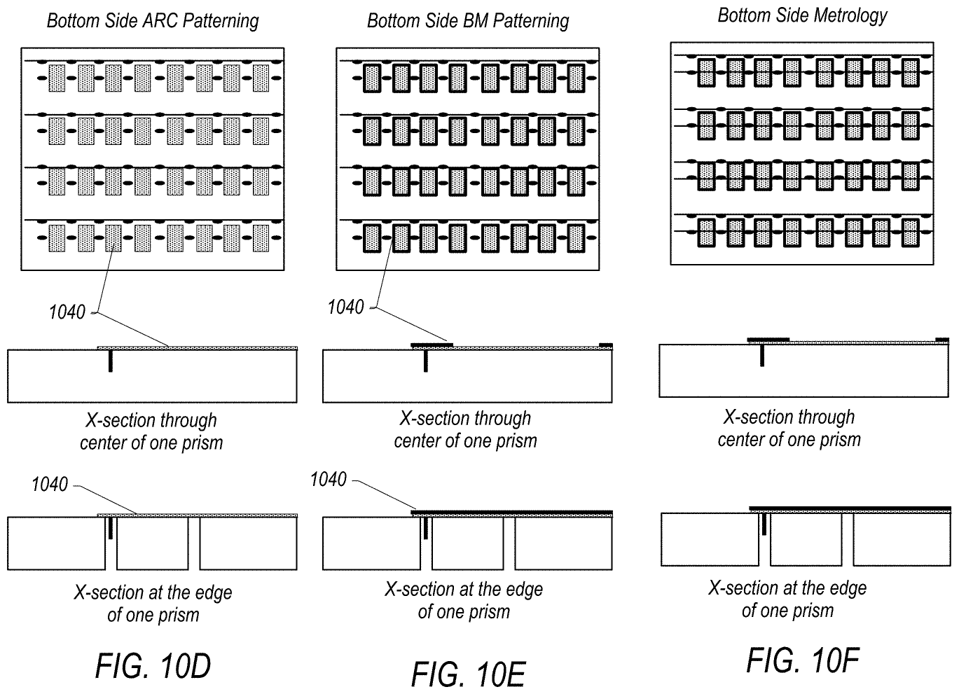

FIGS. 9, 11, 13 and 15 are flowcharts illustrating one embodiment of a method to perform manufacturing multiple single element light folding prisms from a single piece of stock material, according to some embodiments. FIGS. 10, 12, 14 and 16 show block diagrams illustrating the features described regarding FIGS. 9, 11, 13 and 15. Please note that the divisions of actions or steps described in FIGS. 9, 11, 13 and 15 and illustrated in FIGS. 10, 12, 14 and 16 are merely logical divisions for ease of explanation and visualization. The actions and or features described may be performed in a different order and two or more such actions or features may be combined, according to various embodiments. Furthermore, the diagrams illustrated in FIGS. 10, 12, 14 and 16 are not to scale and indicate merely one possible arrangement of features (e.g., cuts, coatings, etc.) that may be used when manufacturing one or more single element light folding prisms, according to some embodiments.

FIG. 9 is a flowchart illustrating one logical phase of a manufacturing multiple single element light folding prisms from a single piece of stock material, according to some embodiments. The description of FIG. 9 below makes reference to FIGS. 10A-10F which show block diagrams visualizing the features described regarding FIG. 9. Beginning with a piece of suitable stock material (such as a glass wafer), one or more pairs of through glass vias may be created in the glass wafer, as illustrated in block 910 according to one embodiment. For example, one or more rows of through vias, such as through vias 1010, may be created in glass wafer 1000. Note that while described as through glass vias, in some embodiments the wafer may be separated into individual prisms by cutting through (e.g., bisecting) pairs of through vias and thus a through via created the wafer may be the equivalent of a channel or notch cut into an individual prism. In some embodiments, the through vias may be essentially oval shaped, but may be shaped differently in different embodiments. While referred to herein generally as a glass wafer, other materials, such as plastic may also be used to manufacture single element light folding prisms using the techniques and or methods described herein. Additionally, while described herein generally as “through glass vias” through vias may also be created in other materials when creating single element light folding prisms out of those materials, such as plastic.

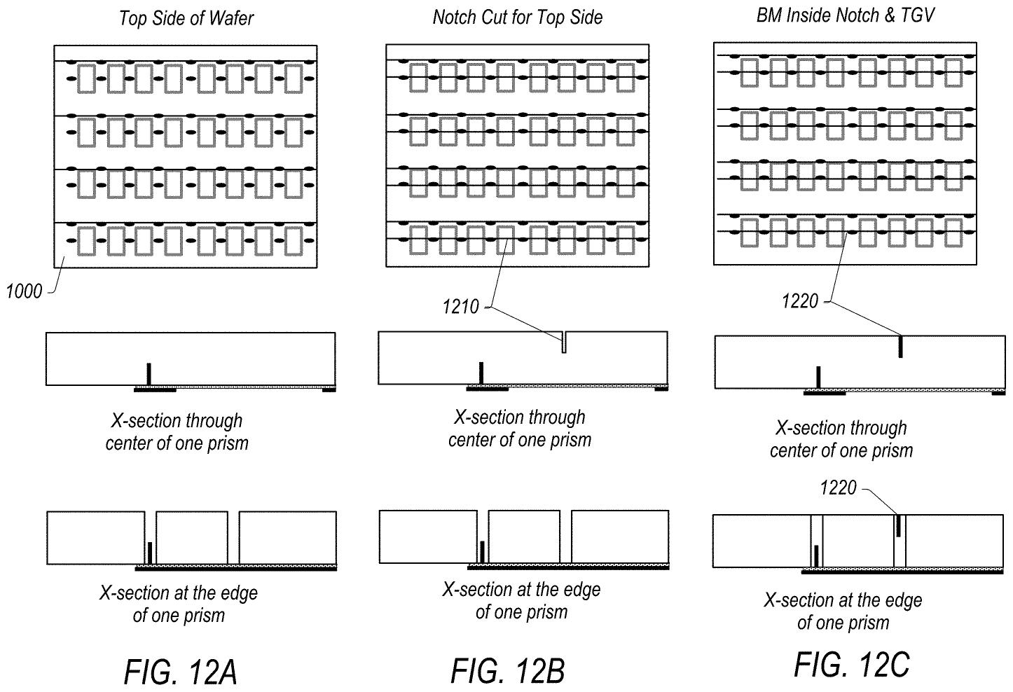

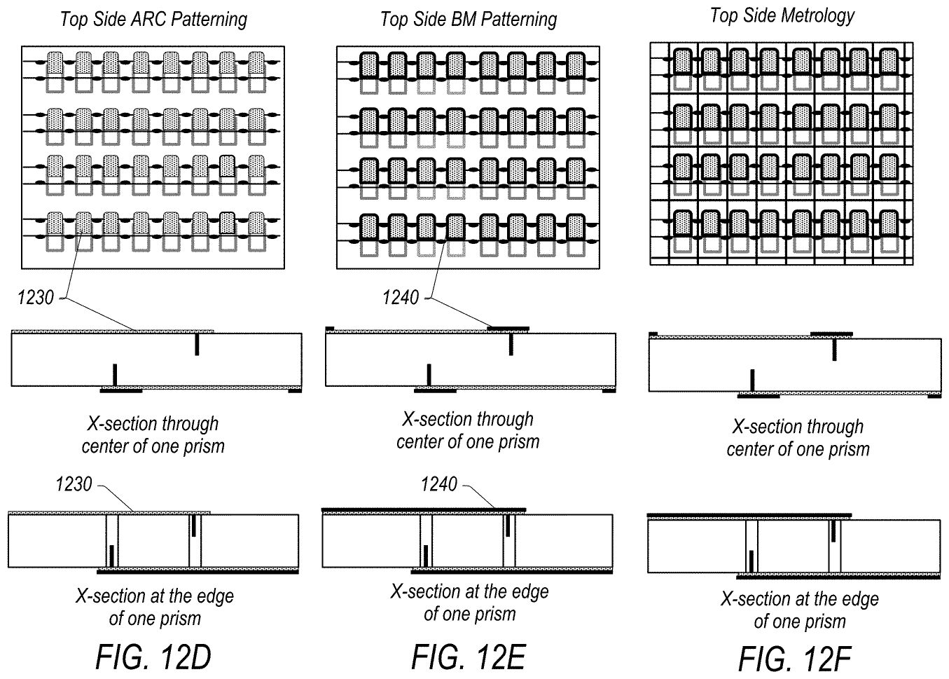

Note that FIGS. 10A-10F (as well as FIGS. 12A-12F) show top down views of an example glass wafer from which multiple single element light folding prisms may be created as well as cross section views (e.g., one longitudinally through the center and one along one edge) of an individual prism at this stage or phase of manufacturing, according to one example embodiment. Also note that FIG. 10A includes dashed rectangles showing the approximate size and location of two individual prism to be manufactured. As shown in block 920, one or more notch cuts may be created connecting sets of the through glass vias. In the example embodiment being described, the stock material is considered bottom side up initially. For instance, one or more notch cuts 1020 may be created on the bottom side (currently the side facing up in FIGS. 10A-F) of the glass wafer 1000. The notch cuts 1020 may cut through the through vias previous created. As shown in FIG. 10B bottom notch cuts 1020 may only connect some of the through vias (other notch cuts from the other, top, side of the wafer may connect the others). For example, when the wafer is separated into individual prisms, two of which are indicated by the dashed rectangles, pairs of through glass vias connected by a notch cut may become an internal aperture mask once appropriate masking is applied, according to some embodiments.

As illustrated in block 930, masking (e.g., black masking or other light blocking coating) may be applied to one or more surfaces of the notch cuts and through glass vias, according to some embodiments. For example, black masking 1030 may be applied to one or more surfaces of notch cuts 1020 and or through vias 1010, as shown in FIG. 10C. As shown in block 940, anti-reflective (AR) coating may be applied to the bottom surface of the wafer in a pattern determined by the particular requirement of the individual prisms being manufactured. For instance, AR coating 1040 may applied to the bottom surface (current facing up in FIG. 10D) in a pattern appropriate for the prisms being produced. Additionally, black masking may be applied to the bottom surface of the wafer in an appropriate pattern, as in block 950 according to some embodiments. While described herein generally, as applying an anti-reflective coating, in some embodiments, one or more layers of masking using any of various suitable materials (or using multiple, different materials in different layers) may be applied so as to achieve low reflection at a glass-masking interface and/or at a making-air interface. As illustrated in FIG. 10E, black masking 1050 may be applied to the bottom surface of wafer 1000. In the example embodiment illustrated in FIG. 10E, black masking 1050 may be applied in a pattern surrounding areas where AR coating 1040 was previously applied, although different patterns may be used in different embodiments. Additionally, as shown in block 960, bottom side metrology may be performed, such as to ensure proper suitability, calibration and/or quality control for the finished prisms.

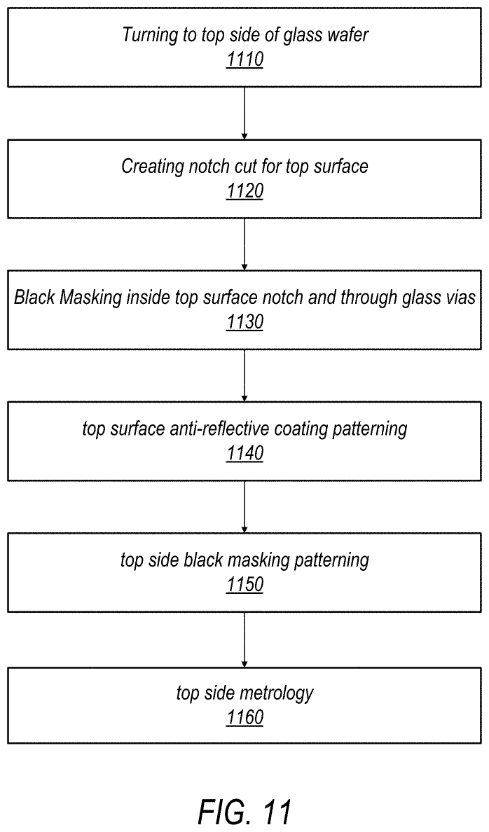

FIG. 11 is a flowchart illustrating one logical phase of a manufacturing multiple single element light folding prisms from a single piece of stock material, according to some embodiments. The description of FIG. 11 below makes reference to FIGS. 12A-10F which show block diagrams visualizing the features described regarding FIG. 11. After switching to the top side of the wafer, as in block 1110, notch cuts for the top side may be created in the wafer, as in block 1120. While described herein as flipping to turning the wafter over to work on the top side of the wafer, these are merely for ease of explanation and in some embodiments, the techniques and/or steps described may be performed without physically turning the stock material over. For example, in some embodiments, both sides of the stock material (e.g., wafer 1000) may be worked (e.g., cut, ground, polished, one or more coatings applied, etc.) without having to rotate or flip the stock over.

For example, one or more rows of through vias, such as through vias 1210, may be created in glass wafer 1000. In some embodiments, the through vias may be essentially oval shaped, but may be shaped differently in different embodiments. In the example embodiment illustrated, notch cuts 1210 may connect the through vias not connected by previous notch cuts 1020. As described above, pairs of through glass vias connected by a notch cut may become an internal aperture mask once appropriate masking is applied, according to some embodiments. As in block 1130, black masking may be applied to one or more surfaces of notch cuts as well as to one or more surfaces of the previously created through glass vias. For instance, as shown FIG. 12C, black masking 1220 may be applied to one or more surfaces of notch cuts 1210 as well as through glass vias 1010. Thus, in some embodiments, through glass vias 1010 may have had black masking applied from both sides of the stock material (e.g., wafer 1000).

Additionally, top surface anti-reflective (AR) coating may be applied in a suitable pattern to the top surface of the stock material (e.g., to the glass wafer), as in block 1140. Thus, as in FIG. 12D, AR coating 1230 may applied to the top surface of wafer 1000 in a pattern appropriate for the prisms being produced. Additionally, black masking may be applied to the top surface of the wafer in an appropriate pattern, as in block 1150 according to some embodiments. As illustrated in FIG. 12E, black masking 1240 may be applied to the top surface of wafer 1000. In the example embodiment illustrated in FIG. 12E, black masking 1240 may be applied in a pattern surrounding areas where AR coating 1230 was previously applied, although different patterns may be used in different embodiments. Additionally, as shown in block 1160, top side metrology may be performed, such as to ensure proper suitability, calibration and/or quality control for the finished prisms.

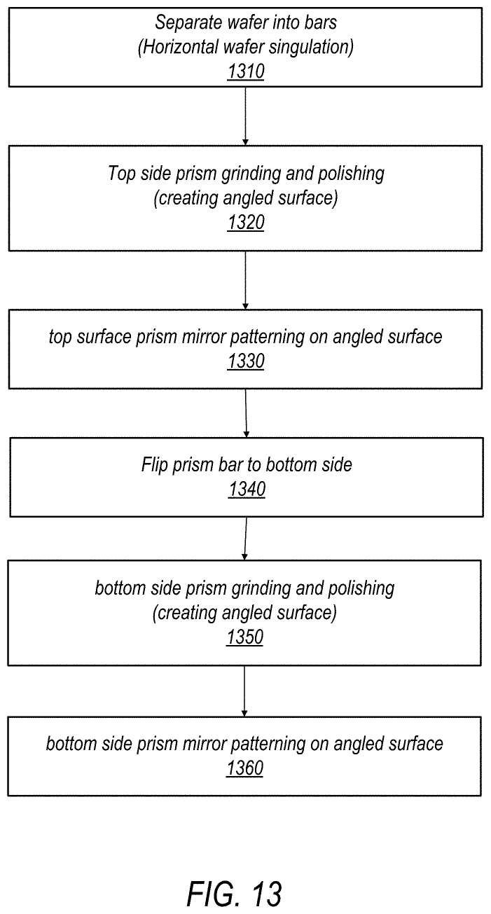

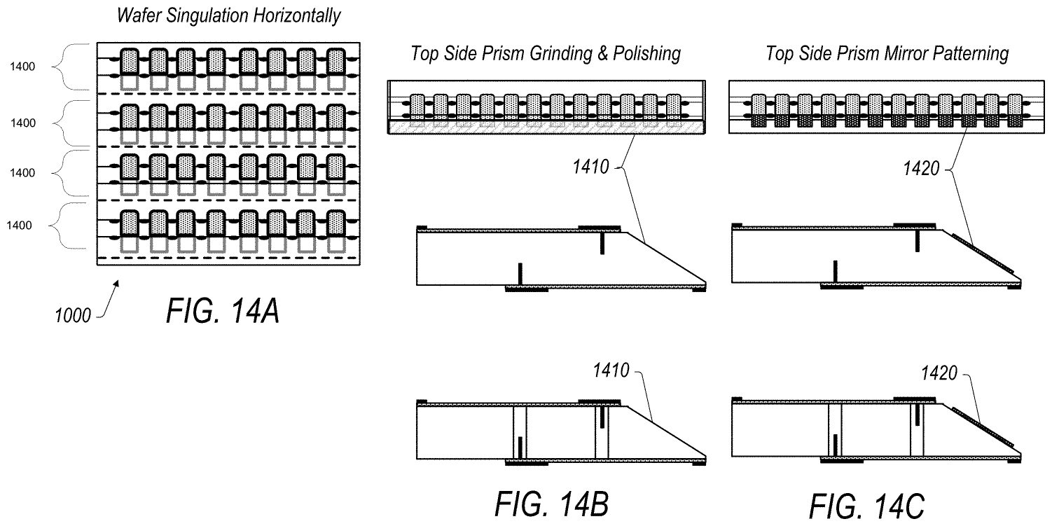

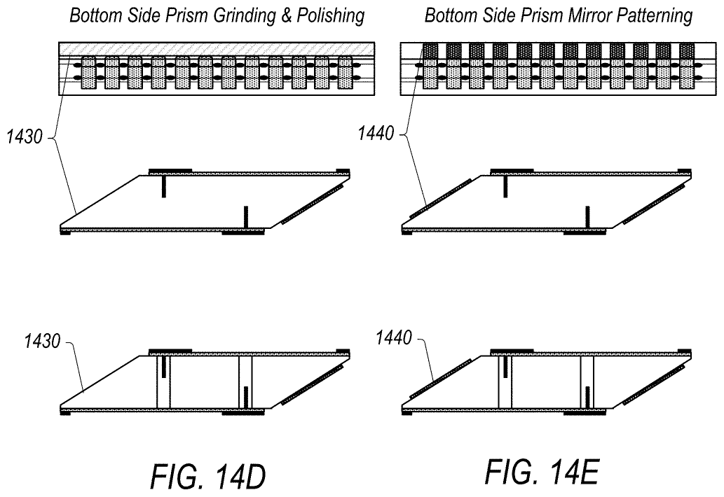

FIG. 13 is a flowchart illustrating one logical phase of a manufacturing multiple single element light folding prisms from a single piece of stock material, according to some embodiments. The description of FIG. 13 below makes reference to FIGS. 14A-10F which show block diagrams visualizing the features described regarding FIG. 13. As shown in block 1310, the stock material (e.g., glass wafer) may be separated into one or more horizontal bars, wherein multiple individual single element light folding prisms may be manufactured from each bar. This separation may be referred to herein as horizontal wafer singulation. For example, the example embodiment illustrated in FIG. 14A, wafer 1000 may be cut or other separated along the dashed lines to create one or more bars 1400.

As shown in block 1320, the top side of the bar (and/or of each bar) may be cut, ground and/or polished to create an angled surface (e.g., angled surface S2 of prism 100), according to some embodiments. As noted above, any of various methods may be used to create angled surfaces, such as grinding, polishing, laser cutting, blade dicing, CNC machining, wire cutting, sand blasting, and/or any of various common methods to trim/process glass substrates. For example, the surface of bar 1400 may be cut, ground and/or polished to create angled surface 1410 (which may correspond to surface S2 of prism 100). Additionally, a high reflective (HR) mirror coating may be applied to the bar and/or specifically to the previously angled surface, as in block 1330. For instance, according to the example embodiment, as shown in FIG. 14C, HR coating 1420 may be applied to surface 1410 in a pattern appropriate for the individual prisms being produced. After turning the bar over (or otherwise working on the other side of the bar) as in block 1340, the bottom side of the bar (and/or of each bar) may be cut, ground and/or polished to create an angled surface (e.g., angled surface S4 of prism 100), as in block 1350 according to some embodiments. For example, as shown in FIG. 14D, the surface of bar 1400 may be cut, ground and/or polished to create angled surface 1430 (which may correspond to surface S4 of prism 100). Additionally, a high reflective (HR) mirror coating may be applied to the bar and/or specifically to the previously angled surface, as in block 1360. For instance, according to the example embodiment, as shown in FIG. 14E, HR coating 1440 may be applied to surface 1430 in a pattern appropriate for the individual prisms being produced.

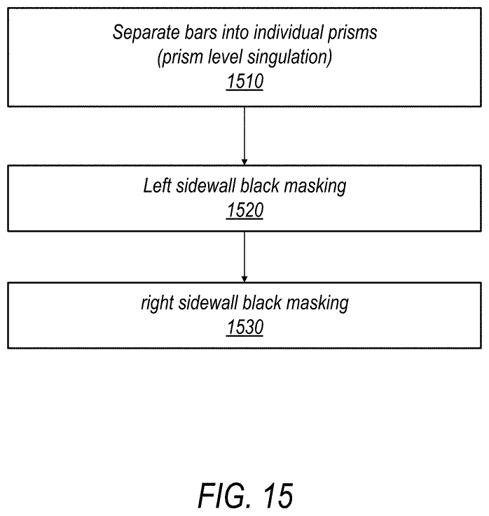

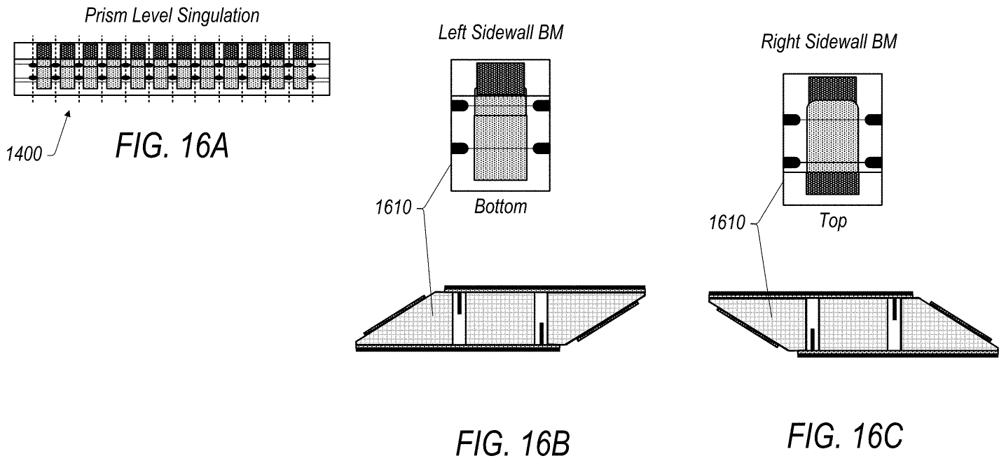

FIG. 15 is a flowchart illustrating one logical phase of a manufacturing multiple single element light folding prisms from a single piece of stock material, according to some embodiments. The description of FIG. 15 below makes reference to FIGS. 16A-16C which show block diagrams visualizing the features described regarding FIG. 15. In some embodiments, as shown in block 1510, the bar (and/or each of the bars) may then be separated or cut into individual prisms, which may be referred to herein as prism level singulation. For example, referring to FIG. 16A, bar 1400 may be cut or otherwise separated along the vertical dashed lines to create multiple individual pieces of prism stock, each of which may be further worked to produce individual single element light folding prisms. As described above, when separated into individual prisms, through glass vias may become the equivalent of channels or notches cut into the individual prisms.

Additionally, as in blocks 1520 and 1530, black masking may be applied to each side or sidewall of the prism, which may also apply the masking to one or more surfaces of the through glass vias of the particular prism, according to some embodiments. For example, as shown in FIGS. 16B and 16C black masking 1610 may be applied to both the left and right sidewalls of the prism. Please note that creating, manufacturing or otherwise making multiple single element light folding prisms is described herein using an example method according to one embodiment. In other embodiments, various steps, methods, and/or features may be performed in another order and fewer or additional steps, methods and/or features may be performed. For example, while described above as making various cuts (e.g., through vias, channels, notches, etc.) and applying one or more coatings (e.g., black masking, anti-reflective, highly-reflective, etc.) to one side of a wafer before making cuts on the other side, in some embodiments, cuts may be made to both sides of the wafer prior to applying any coatings, or alternatively various making cuts and applying coatings may be interspersed (e.g., make one or more cuts, apply one or more coatings, make additional cuts, apply additional coatings, etc.). In addition, the order in which coatings (e.g., black mask, anti-flare, anti-reflective, highly reflective, etc.) are applied may vary from embodiment to embodiment. For example, in one embodiment, an anti-reflective coating may be applied before a black mask coating is applied, while in another embodiment, a black mask coating may be applied prior to applying an anti-reflective coating.

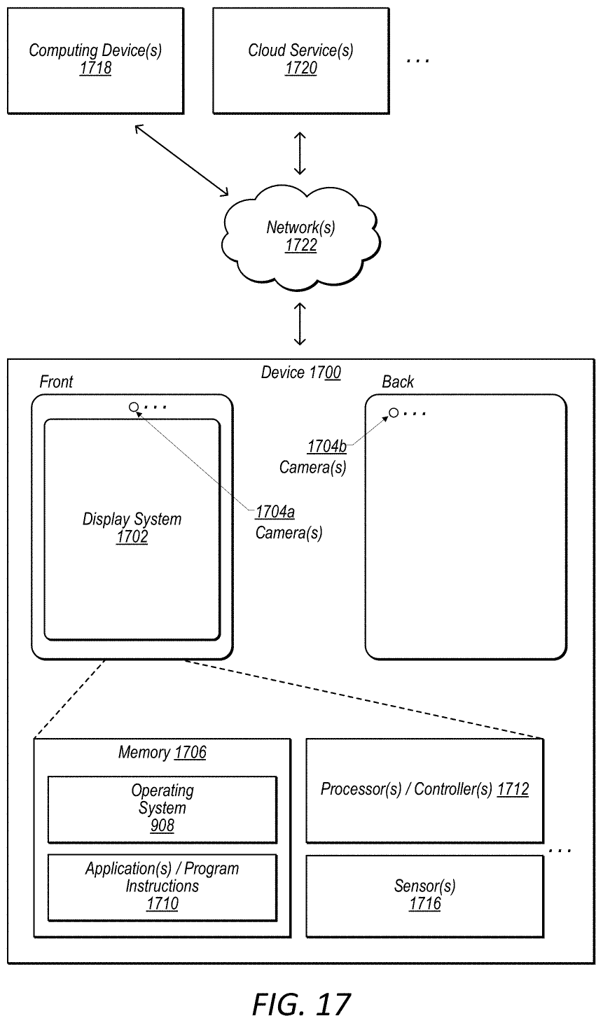

FIG. 17 illustrates a schematic representation of an example device 1700 that may include a camera having an optical system (e.g., optical systems 300 in FIG. 3) in accordance with some embodiments. In some embodiments, the device 1700 may be a mobile device and/or a multifunction device. In various embodiments, the device 1700 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1700 may include a display system 1702 (e.g., comprising a display and/or a touch-sensitive surface) and/or one or more cameras 1704. In some non-limiting embodiments, the display system 1702 and/or one or more front-facing cameras 1704a may be provided at a front side of the device 1700, e.g., as indicated in FIG. 17. Additionally, or alternatively, one or more rear-facing cameras 1704b may be provided at a rear side of the device 1700. In some embodiments comprising multiple cameras 1704, some or all of the cameras may be the same as, or similar to, each other. Additionally, or alternatively, some or all of the cameras may be different from each other. In various embodiments, the location(s) and/or arrangement(s) of the camera(s) 1704 may be different than those indicated in FIG. 17.

Among other things, the device 1700 may include memory 1706 (e.g., comprising an operating system 1708 and/or application(s)/program instructions 1710), one or more processors and/or controllers 1712 (e.g., comprising CPU(s), memory controller(s), display controller(s), and/or camera controller(s), etc.), and/or one or more sensors 1716 (e.g., orientation sensor(s), proximity sensor(s), and/or position sensor(s), etc.). In some embodiments, the device 1700 may communicate with one or more other devices and/or services, such as computing device(s) 1718, cloud service(s) 1720, etc., via one or more networks 1722. For example, the device 1700 may include a network interface (e.g., network interface 1710) that enables the device 1700 to transmit data to, and receive data from, the network(s) 1722. Additionally, or alternatively, the device 1700 may be capable of communicating with other devices via wireless communication using any of a variety of communications standards, protocols, and/or technologies.

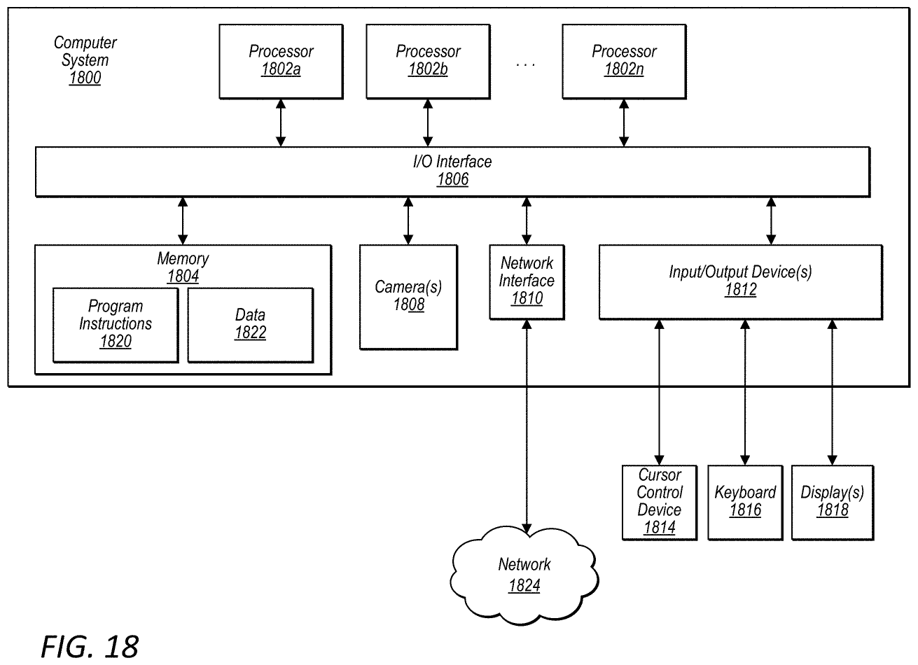

FIG. 18 illustrates a schematic block diagram of an example computing device, referred to as computer system 1000, that may include or host embodiments of a camera having an optical system, e.g., as described herein. In addition, computer system 1800 may implement methods for controlling operations of the camera and/or for performing image processing images captured with the camera. In some embodiments, the device 1700 (described herein with reference to FIG. 17) may additionally, or alternatively, include some or all of the functional components of the computer system 1800 described herein.

The computer system 1800 may be configured to execute any or all of the embodiments described above. In different embodiments, computer system 1800 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 8000 includes one or more processors 1802 coupled to a system memory 1004 via an input/output (I/O) interface 1806. Computer system 1800 further includes one or more cameras 1008 coupled to the I/O interface 1806. Computer system 1800 further includes a network interface 1010 coupled to I/O interface 1806, and one or more input/output devices 1812, such as cursor control device 1014, keyboard 1816, and display(s) 1818. In some cases, it is contemplated that embodiments may be implemented using a single instance of computer system 1800, while in other embodiments multiple such systems, or multiple nodes making up computer system 1800, may be configured to host different portions or instances of embodiments. For example, in one embodiment some elements may be implemented via one or more nodes of computer system 1800 that are distinct from those nodes implementing other elements.

In various embodiments, computer system 1800 may be a uniprocessor system including one processor 1802, or a multiprocessor system including several processors 1802 (e.g., two, four, eight, or another suitable number). Processors 1802 may be any suitable processor capable of executing instructions. For example, in various embodiments processors 1802 may be general-purpose or embedded processors implementing any of a variety of instruction set architectures (ISAs), such as the x86, PowerPC, SPARC, or MIPS ISAs, or any other suitable ISA. In multiprocessor systems, each of processors 1802 may commonly, but not necessarily, implement the same ISA.

System memory 1804 may be configured to store program instructions 1820 accessible by processor 1802. In various embodiments, system memory 1804 may be implemented using any suitable memory technology, such as static random-access memory (SRAM), synchronous dynamic RAM (SDRAM), nonvolatile/Flash-type memory, or any other type of memory. Additionally, existing camera control data 1822 of memory 1804 may include any of the information or data structures described above. In some embodiments, program instructions 1820 and/or data 1822 may be received, sent or stored upon different types of computer-accessible media or on similar media separate from system memory 1804 or computer system 1800. In various embodiments, some or all of the functionality described herein may be implemented via such a computer system 1800.

In one embodiment, I/O interface 1806 may be configured to coordinate I/O traffic between processor 1802, system memory 1804, and any peripheral devices in the device, including network interface 1810 or other peripheral interfaces, such as input/output devices 1812. In some embodiments, I/O interface 1806 may perform any necessary protocol, timing or other data transformations to convert data signals from one component (e.g., system memory 1804) into a format suitable for use by another component (e.g., processor 1802). In some embodiments, I/O interface 1806 may include support for devices attached through various types of peripheral buses, such as a variant of the Peripheral Component Interconnect (PCI) bus standard or the Universal Serial Bus (USB) standard, for example. In some embodiments, the function of I/O interface 1806 may be split into two or more separate components, such as a north bridge and a south bridge, for example. Also, in some embodiments some or all of the functionality of I/O interface 1806, such as an interface to system memory 1804, may be incorporated directly into processor 1802.

Network interface 1810 may be configured to allow data to be exchanged between computer system 1800 and other devices attached to a network 1824 (e.g., carrier or agent devices) or between nodes of computer system 1800. Network 1824 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1810 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1812 may, in some embodiments, include one or more display terminals, keyboards, keypads, touchpads, scanning devices, voice or optical recognition devices, or any other devices suitable for entering or accessing data by one or more computer systems 1800. Multiple input/output devices 1812 may be present in computer system 1800 or may be distributed on various nodes of computer system 1800. In some embodiments, similar input/output devices may be separate from computer system 1800 and may interact with one or more nodes of computer system 1800 through a wired or wireless connection, such as over network interface 1810.

Those skilled in the art will appreciate that computer system 1800 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1800 may be transmitted to computer system 1800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A prism, comprising:
a single, monolithic, prism comprising:
at least four surfaces; and
one or more interior aperture masks;
wherein a first surface is parallel to a third surface;
wherein a second surface is parallel to a fourth surface; and
wherein an angle where the first surface meets the second surface is less than 90 degrees.

2. The prism of claim 1, wherein at least one of the interior aperture masks comprises:
a first channel in a left side surface between the first surface and the third surfaces;
a second channel in a right side surface opposite the channel in the left side surface; and
a third channel in the first surface connecting the first and second channels to a depth less than a thickness of the prism between the first surface and the third surface.

3. The prism of claim 2, further comprising:
a dark masking that covers, at least partially, one or more interior surfaces of the first channel, the second channel or the third channel.

4. The prism of claim 2, further comprising another interior aperture mask, wherein the another interior aperture mask comprises:
a fourth channel in a left side surface between the first surface and the third surfaces;
a fifth channel in a right side surface opposite the channel in the left side; and
a sixth channel in the third surface connecting the fourth and fifth channels to a depth less than a thickness of the prism between the first surface and the third surface.

5. The prism of claim 1, further comprising a highly reflective coating covering, at least partially, the second surface or the fourth surface.

6. The prism of claim 1, further comprising an anti-reflective coating covering, at least partially, the first surface or the third surface.

7. The prism of claim 1, further comprising a dark masking covering, at least partially, the first surface or the third surface.

8. The prism of claim 1, further comprising:
wherein the prism comprises a parallelogram shape; and
wherein the angle between the first surface and the second surface is between 25 and 35 degrees.

9. The prism of claim 1, wherein the prism is configured to:
transmit light passing through a first surface into the prism;
reflect, at a second surface of the prism, at least some of the light passing through the first surface of the prism;
reflect, at the first surface of the prism, at least some of the light reflected from the second surface of the prism;
reflect, at a third surface of the prism, at least some of the light reflected from the first surface of the prism; and
reflect, at a fourth surface of the prism, at least some of the light reflected from the third surface of the prism to pass through the third surface out of the prism.

10. A camera, comprising:
one or more lenses;
an image sensor; and
a prism between the one or more lenses and the image sensor;
wherein the prism comprises:
at least four surfaces; and
one or more interior aperture masks;
wherein a first surface is parallel to a third surface;
wherein a second surface is parallel to a fourth surface; and
wherein an angle where the first surface meets the second surface is less than 90 degrees.

11. The camera of claim 10, wherein at least one of the interior aperture masks comprises:
a first channel in a left side surface between the first surface and the third surfaces;
a second channel in a right side surface opposite the channel in the left side surface;
a third channel in the first surface connecting the first and second channels to a depth less than a thickness of the prism between the first surface and the third surface; and
a dark masking covering, at least partially, one or more interior surfaces of the first channel, the second channel or the third channel.

12. The camera of claim 11, further comprising:
another interior aperture mask, comprising:
a fourth channel in a left side surface between the first surface and the third surfaces;
a fifth channel in a right side surface opposite the channel in the left side;
a sixth channel in the third surface connecting the fourth and fifth channels to a depth less than a thickness of the prism between the first surface and the third surface; and
a dark masking covering, at least partially, one or more interior surfaces of the fourth channel, the fifth channel and the sixth channel.

13. The camera of claim 10, wherein the prism further comprises a highly reflective coating covering, at least partially, the second surface or the fourth surface.

14. The camera of claim 10, wherein the prism further comprises an anti-reflective coating covering, at least partially, the first surface or the third surface.

15. A method, comprising:
creating a plurality of interior aperture masks within a glass wafer, wherein creating at least one of the interior aperture masks comprises:
creating a pair of through glass vias through the glass wafer, wherein the through glass vias pass through the glass wafer from a top surface to a bottom surface of the glass wafer;
creating a notch in the top surface or the bottom surface connecting respective pairs of the through glass vias, wherein the notch is created to a depth less than the thickness of the glass wafer; and
applying a dark masking to cover, at least partially, one or more interior surfaces of the pair of through glass vias and the notch;
separating the glass wafer into a plurality of individual prisms, wherein one or more of the individual prisms comprises:
one or more of the interior aperture masks; and
at least four surfaces, wherein a first surface is parallel to a third surface, wherein a second surface is parallel to a fourth surface; and wherein an angle where the first surface meets the second surface is less than 90 degrees.

16. The method of claim 15, further comprising:
applying, prior to said separating, an anti-reflective coating to at least a portion of the top and bottom surfaces of the glass wafer, wherein each of the plurality of individual prisms includes a portion of the anti-reflective coating.

17. The method of claim 15, further comprising:
applying, prior to said separating, a black mask coating to the top and bottom surfaces of the glass wafer, wherein each of the plurality of individual prisms includes a portion of the black mask coating.

18. The method of claim 15, wherein one or more of the individual prisms each include two interior aperture masks, wherein one of the two interior aperture masks comprises a notch in the top surface and wherein another of the two interior aperture masks comprises a notch in bottom surface, and wherein at least one of the notches comprises a periodic or aperiodic structure varying the depth of the notch in the respective individual prism.

19. The method of claim 15, further comprising:
separating the glass wafer into a plurality of prism bars, wherein each respective prism bar comprises a plurality of the interior aperture masks; and
creating the second and fourth surfaces along opposite long edges of each respective prism bar, wherein the second and fourth surfaces are created parallel to each other and angled such that the respective prism bar has a transverse parallelogram shape.

20. The method of claim 19, further comprising:
transversely separating the prism bars into the plurality of individual prisms;
wherein each respective individual prism includes:
a portion of the second surface on a first end of the prism;
a portion of the fourth surface on a second end of the prism opposite the first end.
